(19) United States
(12) Patent Application Publication
(10) Pub. No.: US 2020/0102247 A1
(43) Pub. Date: Apr. 2, 2020

(54) MULTILAYER ARTIFICIAL STONE AND PREPARATION METHOD THEREOF

(71) Applicant: FOSHAN YIXIN STONE CO., LTD, Foshan (CN)

(72) Inventors: Guoming Zhang, Foshan (CN); Zhijian Liang, Foshan (CN); Jiansong Xian, Foshan (CN); Huaigui Xiao, Foshan (CN); Junxian Liu, Foshan (CN)

(21) Appl. No.: 16/519,019

(22) Filed: Jul. 23, 2019

(30) Foreign Application Priority Data
Sep. 27, 2018 (CN) 201811128162.8

(51) Int. Cl. C04B 26/18; C04B 14/28; B32B 9/00; B28B 1/30

(52) U.S. Cl. CPC C04B 26/18; C04B 14/28; C04B 2111/82; B28B 1/30; B32B 9/002

(57) ABSTRACT

The present invention involves a multiplayer artificial stone and its preparation method. The decorative layer comprises the following components in percentage by weight: 80%-90% of a decorative stone, 5%-15% of an unsaturated polyester resin, 0.6%-2% of a coupling agent, 0.7%-1.2% of a curing agent, and 1%-5% of a pigment filler. The bottom layer comprises the following components in percentage by weight: 65%-78% of a calcium carbonate stone, 10%-18% of an unsaturated polyester resin, 0.6%-2% of a coupling agent, 0.7%-1.2% of a curing agent, and 1-15% of a pigment filler. The preparation method involves preparing the decorative layer and the bottom layer separately and then binding the two layers together by pressing. This arrangement allows the multilayer artificial stone to have good decorative effect and product quality; in addition, each layer contains only one type of stone, therefore its preparation is easier and can be more precisely controlled, lowering production cost.

### CROSS REFERENCE TO RELATED APPLICATIONS

The present application claim the priority of Chinese Patent Application No. 201811128162.8 filed on Sep. 27, 2018, the contents of which are hereby incorporated by reference.

### FIELD OF THE INVENTION

The invention relates to the technical field of artificial stone surfaces, in particular to a multilayer artificial stone and a preparation method thereof.

### BACKGROUND OF THE INVENTION

In recent years, the manufacture and sales of artificial stones have gradually improved and matured. The term “artificial stones” usually refers to artificial stone solid surfaces, artificial quartz stones, and artificial granite stones, among others. There are many types of artificial stones; different types of artificial stones have different components. Most artificial quartz stones are produced using 70-95% of quartz, resin, pigments, and other additives including conditioners, adhesives or curing agents, and under vacuum, high temperature and pressure. Quartz sands and quartz powder in artificial stones are produced by grinding mining products which are non-renewable. When artificial stones are directly mixed, pressed, and not divided into different layers, in order to achieve good decorative effects and material properties, the main stone used in the preparation of artificial stones could only be quartz sand or quartz powder, giving rise to high manufacturing cost.

### SUMMARY OF THE INVENTION

To overcome the deficiencies of the prior art, the objective of the present invention is to provide a preparation method of a multilayer artificial stone by separately preparing a decorative layer and a bottom layer, followed by pressing and binding. The multilayer artificial stone has good product quality and reduced production cost.

To achieve the objective of the present invention, the technical solutions of the present invention are as follows.

A multilayer artificial stone, comprising a decorative layer and a bottom layer which are arranged from top to bottom, the decorative layer and the bottom layer bind together to form an integral body; the decorative layer comprises the following components in percentage by weight: 80%-90% of a decorative stone, 5%-15% of an unsaturated polyester resin, 0.6%-2% of a coupling agent, 0.7%-1.2% of a curing agent, and 1%-5% of a pigment filler;

the bottom layer comprises the following components in percentage by weight: 65%-78% of a calcium carbonate stone, 10%-18% of an unsaturated polyester resin, 0.6%-2% of a coupling agent, 0.7%-1.2% of a curing agent, and 1-15% of a pigment filler. Preferably, a bottom decorative layer is provided underneath the bottom layer; the bottom decorative layer and the bottom layer bind together to form an integral body; the bottom decorative layer comprises the following components in percentage by weight: 80%-90% of a decorative stone, 5%-15% of an unsaturated polyester resin, 0.6%-2% of a coupling agent, 0.7%-1.2% of a curing agent, and 1%-5% of a pigment filler.

The decorative layer and the bottom decorative layer are respectively provided at two sides of the bottom layer. This allows the multilayer artificial stone to have a better overall decorative effect. In addition, the two sides of the bottom layer are coated to provide a greater degree of protection to the bottom layer, preventing damage to the bottom layer. The production process is simplified, the production cost is lowered, and good product quality is achieved.

It should be noted that the two sides of the bottom layer refer to the upper surface and the lower surface of the bottom layer.

More preferably, the decorative stone is glass sand and/or a quartz stone. When two different kinds of stones are prepared as separate layers and then pressed to bind together and form an integrated structure, the stress experienced by each layer during curing may be different due to the different materials contained in each layer. This is likely to lead to deformation or even cracking of the artificial stone obtained. Therefore, this method is not recommended in the prior art. To solve this problem, in the present invention, the weight percentage of the stone contained in each layer is limited in such a way that the material parameters of different stones in different layers are similar. Then, a dispersion of pigment and resin prepared from similar weight percentages of unsaturated polyester resin, coupling agent, curing agent, and pigment filler mixes with the stone to produce layers with similar material parameters. This prevents the deformation or cracking of the multilayer artificial stone obtained after curing under the action of excessive stress present between the layers. In addition, glass is a recyclable resource and has a good decorative effect. Employing glass to produce artificial stones on a large scale allows decreased reliance on ore resources and reduced production cost.

In the decorative layer, if the amount of the decorative stone is less than 80 wt %, production cost would increase and the hardness of the artificial stone would decrease; if the amount of the decorative stone is more than 90 wt %, binding would not be firm. If the amount of the unsaturated polyester resin is less than 5 wt %, binding would not be firm; if the amount of the unsaturated polyester resin is more than 15 wt %, the cost would be too high and the hardness of the artificial stone would be unsatisfactory.

In the bottom layer, if the amount of calcium carbonate stone is less than 65 wt %, the production cost would not be significantly reduced; if the amount of calcium carbonate stone is more than 78 wt %, the artificial stone would be soft and prone to deformation. If the amount of the unsaturated polyester resin is less than 10 wt %, binding would not be firm; if the amount of the unsaturated polyester resin is more than 18 wt %, the cost would be too high.

In view of the above, in the present invention, the stone is mixed with a dispersion of pigment and resin that is prepared from a specific ratio of an unsaturated polyester resin, a coupling agent, a curing agent, and a pigment filler. As a result, the material parameters of the layers prepared are similar. This prevents the deformation or cracking of the multilayer artificial stone obtained after curing under the action of excessive stress present between the layers. The artificial stone produced reaches a good balance in terms of hardness, strength, cost, among other factors, and is of low cost and high quality.

Preferably, a thickness of the decorative layer or the bottom decorative layer is 0.5 cm to 1.5 cm; a thickness of the bottom layer is 0.5 cm to 2.5 cm. The decorative layer and the bottom decorative layer are mainly for decoration purposes; therefore, they should be made thinner to reduce cost. The bottom layer is mainly calcium carbonate; its hardness, anti-stain ability, and chemical resistance are relatively poor, so the bottom layer should be made thicker. In addition, it is necessary to make sure that the stress exerted by the two layers are similar; therefore, the thickness of the bottom decorative layer and the thickness of the bottom layer are limited to the range specified above to obtain a multilayer artificial stone with good decorative effect, desirable quality parameters, and is not prone to deformation and cracking.

More preferably, the glass sand has a particle size of 26-150 mesh, the quartz stone is quartz powder, and the quartz powder has a particle size of 200-450 mesh. The particle sizes of the glass sand and the quartz stone mentioned above could act to further improve the fluidity of the artificial glass stone during its preparation process. This allows flat pressing and prevents cracking. It is thus essential to limit the sizes of the glass sand and the quartz stone to improve the quality of the multilayer artificial stone.

A method to prepare the multilayer artificial stone described above comprises the following steps:

A: heating the unsaturated polyester resin to 20-30° C.; adding the coupling agent, the curing agent, and the pigment filler; stirring thoroughly to obtain a dispersion of pigment and resin;

B. adding the decorative stone and the dispersion of pigment and resin into a trough, stirring thoroughly to obtain a decorative layer pre-formed material;

C. spreading the decorative layer pre-formed material in a mold frame, pre-pressing to obtain the decorative layer;

D. transferring the calcium carbonate stone and the dispersion of pigment and resin into the trough, stirring thoroughly to obtain a bottom layer pre-formed material;

E. spreading the bottom layer pre-formed material on an upper surface of the decorative layer in the mold frame; pressing to form the bottom layer which binds to the decorative layer to form a primary preliminary stone surface;

F. curing the primary preliminary stone surface in a curing oven; polishing a surface of the decorative layer to obtain the multilayer artificial stone.

Pre-pressing is carried out to obtain a decorative layer that is compact. Pressing is then carried out after adding the bottom layer pre-formed material; the pre-pressing process prevents the infiltration of calcium carbonate material into the decorative layer during pressing. This allows the decorative layer to have a good decorative effect.

When the bottom decorative layer is provided, a step E1 is provided between step E and step F:

E1. spreading the decorative layer pre-formed material on an upper surface of the bottom layer in the mold frame; pressing with a pressure of 1-2 Mpa to obtain a preliminary stone surface; wherein in step F, the preliminary stone surface is cured in the curing oven stead of the primary preliminary stone surface.

More preferably, the stirring in step A involves stirring at a high speed for 1-2 minutes; when a mixer is stirring at the high speed, its operating frequency is 40-60 Hz; the stirring in step B and step D involves stirring at a low speed for 4-6 minutes; when the mixer is stirring at the low speed, its operating frequency is 10-20 Hz. The operating frequencies of the mixer are different in different steps. This, in combination with the mixing time specified, allows better fluidity of the decorative stone and prevents the decrease in viscosity of the dispersion of pigment and resin due to overmixing. As a result, the surface decorative stone is prevented from falling off, the decorative layer is flat, the preparation process is more precise and efficient, and the product quality is better.

Preferably, the pre-pressing is performed under a pressure of 0.1 MPa to 0.3 MPa; the pressing is performed under a pressure of 1 MPa to 2 MPa. In the multilayer artificial stone, the layers are bound together by pressing. Due to the fact that the materials and thickness of each layer are different, different pressure is required for pressing and pre-pressing at different stages of binding to prevent damages to the decorative layer and the bottom decorative layer, and to prevent deformation or cracking of the multilayer artificial stone.

More preferably, in step F, the curing of the primary preliminary stone surface is carried out at a temperature of 70-110° C. The multilayer artificial stone is made from layers of different stones bound together by pressing. During curing, the stress exerted by each layer may change differently, creating a stress difference between layers. A stress difference that is too big may affect product quality. Therefore, the curing temperature needs to be precisely controlled to control the rate of stress change in each layer.

The present invention involves a multiplayer artificial stone and its preparation method. The preparation method involves preparing the decorative layer and the bottom layer separately and then binding the two layers together by pressing. The bottom layer is made from a material of lower cost, i.e., calcium carbonate; the decorative layer, which is exposed to the outside, is made from a more expensive decorative stone. This arrangement allows the multilayer artificial stone to have good decorative effect and product quality; in addition, each layer contains only one type of stone, therefore its preparation is easier and can be more precisely controlled, lowering production cost.

### DETAILED DESCRIPTION OF THE ILLUSTRATED EMBODIMENTS

To more clearly illustrate the technical solutions of the present invention, the present invention is further described in detail below with reference to the illustrated embodiments.

### Embodiments 1-16

A multilayer artificial stone, which comprises a decorative layer and a bottom layer which are arranged from top to bottom, the decorative layer and the bottom layer bind together to form an integral body.

The decorative layer comprises the following components: a decorative stone, an unsaturated polyester resin, a coupling agent, a curing agent, and a pigment filler; the bottom layer comprises the following components: a calcium carbonate stone, an unsaturated polyester resin, a coupling agent, a curing agent, and a pigment filler.

The multilayer artificial stone is prepared as follows:

A: Heating the unsaturated polyester resin to 20-30° C.; adding the coupling agent, the curing agent, and the pigment filler to the unsaturated polyester resin; stirring the mixture obtained at a high speed for 1-2 minutes to obtain a dispersion of pigment and resin; when the mixer is stirring at a high speed, its operating frequency is 40-60 Hz.

B: Adding the decorative stone and the dispersion of pigment and resin into a trough, stirring at a low speed for 4-6 minutes to obtain a decorative layer pre-formed material; when the mixer is stirring at a low speed, its operating frequency is 10-20 Hz.

C. Spreading the decorative layer pre-formed material in a mold frame; pre-pressing with a pressure of 0.1 MPa to 0.3 MPa to obtain the decorative layer.

D. Transferring the calcium carbonate stone and the dispersion of pigment and resin into the trough, stirring at a low speed for 4-6 minutes to obtain a bottom layer pre-formed material; when the mixer is stirring at a low speed, its operating frequency is 10-20 Hz.

E. Spreading the bottom layer pre-formed material on the upper surface of the decorative layer in the mold frame; pressing with a pressure of 1-2 MPa to form a bottom layer which binds to the decorative layer to form a preliminary stone surface.

F. Curing the preliminary stone surface in a curing oven; polishing the surface of the decorative layer to obtain the multilayer artificial stone.

Particularly, the decorative stone is glass sand and/or a quartz stone, the particle size of the glass sand is 80 mesh, the particle size of the quartz stone is 325 mesh. The pre-pressing step is carried out via a pre-pressing roller. In step F, the curing temperature of the curing oven is 70-110° C.

Following the components and preparation method stated above, the amount of each component is adjusted in other embodiments to obtain different multilayer artificial stones each comprising a decorative layer and a bottom layer. The qualities of the products obtained are compared; see Tables 1-3 below.

TABLE 1
Components of the Decorative Layer

| | Components of the decorative layer | | | | | |
|---|---|---|---|---|---|---|
| | (in percentage by weight) | | | | | Type of |
| | Decorative | Unsaturated | Coupling | Curing | Filler | decorative |
| Embodiment | stone | polyester resin | agent | agent | pigment | stone |
| 1 | 80 | 17.3 | 0.6 | 0.7 | 1.4 | Glass sand |
| 2 | 85 | 12.3 | 0.6 | 0.7 | 1.4 | |
| 3 | 90 | 7.3 | 0.6 | 0.7 | 1.4 | |
| 4 | 80 | 17.3 | 0.6 | 0.7 | 1.4 | Quartz sand |
| 5 | 85 | 12.3 | 0.6 | 0.7 | 1.4 | |
| 6 | 90 | 7.3 | 0.6 | 0.7 | 1.4 | |
| 7 | 80 | 17.3 | 0.6 | 0.7 | 1.4 | Glass sand |
| 8 | 85 | 8 | 1.0 | 1.0 | 5 | |
| 9 | 90 | 5 | 0.6 | 0.7 | 3.7 | |
| 10 | 80 | 15 | 2 | 1.2 | 1.8 | Quartz sand |
| 11 | 85 | 8.5 | 1.5 | 1.0 | 4 | |
| 12 | 90 | 7 | 1.0 | 1.0 | 1.0 | |
| 13 | 60 | 25 | 12 | 1.2 | 1.8 | |
| 14 | 91 | 3.5 | 0.5 | 1.0 | 4 | |
| 15 | 90 | 7 | 1.0 | 1.0 | 1.0 | |
| 16 | 85 | 8.5 | 1.5 | 1.0 | 4 | |

TABLE 2
Components of the Bottom Layer

| | Components of the bottom layer | | | | | |
|---|---|---|---|---|---|---|
| | (in percentage by weight) | | | | | Type of |
| | Calcium | | | | | calcium |
| | carbonate | Unsaturated | Coupling | Curing | Filler | carbonate |
| Embodiment | stone | polyester resin | agent | agent | pigment | stone |
| 1 | 65 | 18 | 0.8 | 1.2 | 15 | Calcium |
| 2 | 70 | 15 | 0.6 | 1.0 | 13.4 | carbonate |
| 3 | 78 | 10 | 2 | 1.2 | 8.8 | |
| 4 | 65 | 18 | 2 | 1.2 | 13.8 | |
| 5 | 70 | 13 | 2 | 1.2 | 13.8 | |
| 6 | 78 | 16 | 1.3 | 0.7 | 4 | |
| 7 | 65 | 18 | 2 | 1.2 | 13.8 | |
| 8 | 70 | 13 | 2 | 1.2 | 13.8 | |
| 9 | 78 | 10 | 2 | 1.2 | 8.8 | |
| 10 | 65 | 18 | 2 | 1.2 | 13.8 | |
| 11 | 70 | 13 | 2 | 1.2 | 13.8 | |
| 12 | 78 | 18 | 2 | 1.0 | 1.0 | |
| 13 | 65 | 18 | 2 | 1.2 | 13.8 | |
| 14 | 70 | 13 | 2 | 1.2 | 13.8 | |
| 15 | 48 | 28 | 13 | 10 | 1.0 | |
| 16 | 70 | 13 | 2 | 1.2 | 13.8 | |

TABLE 3
Properties of Multilayer Artificial Stones

| | Thickness of | Thickness of | Heating | |
|---|---|---|---|---|
| | the decorative | the bottom | temperature | Product |
| Embodi- | layer | layer | in step A | quality testing |
| ment | (cm) | (cm) | (° C.) | results |
| 1 | 0.5 | 0.5 | 30 | Good |
| 2 | 1.0 | 1.5 | 40 | Good |
| 3 | 1.5 | 2.5 | 50 | Good |
| 4 | 0.5 | 1.0 | 30 | Good |
| 5 | 1.0 | 2.0 | 40 | Good |
| 6 | 1.5 | 2.0 | 50 | Good |
| 7 | 0.5 | 0.5 | 30 | Good |
| 8 | 1.0 | 1.5 | 40 | Good |
| 9 | 1.5 | 2.5 | 50 | Good |
| 10 | 0.5 | 1.0 | 30 | Good |
| 11 | 1.0 | 2.0 | 40 | Good |
| 12 | 1.5 | 2.0 | 50 | Good |
| 13 | 0.5 | 1.0 | 30 | Poor |
| | | | | decorative |
| | | | | effect |
| 14 | 1.0 | 2.0 | 40 | Serious |
| | | | | cracking |
| 15 | 1.5 | 2.0 | 50 | Cracking |
| 16 | 3.0 | 1.0 | 40 | Deformation |

### Embodiments 17-32

A multilayer artificial stone, which comprises a decorative layer, a bottom layer, a bottom decorative layer which are arranged from top to bottom, the decorative layer, the bottom layer, and the bottom decorative layer bind together to form an integral body.

The decorative layer comprises the following components: a decorative stone, an unsaturated polyester resin, a coupling agent, a curing agent, and a pigment filler; the bottom layer comprises the following components: a calcium carbonate stone, an unsaturated polyester resin, a coupling agent, a curing agent, and a pigment filler.

The bottom decorative layer comprises the following components: a calcium carbonate stone, an unsaturated polyester resin, a coupling agent, a curing agent, and a pigment filler.

The multilayer artificial stone is prepared as follows:

A: Heating the unsaturated polyester resin to 20-30° C.; adding the coupling agent, the curing agent, and the pigment filler to the unsaturated polyester resin; stirring the mixture obtained at a high speed for 1-2 minutes to obtain a dispersion of pigment and resin; when the mixer is stirring at a high speed, its operating frequency is 40-60 Hz.

B: Adding the decorative stone and the dispersion of pigment and resin into a trough, stirring at a low speed for 4-6 minutes to obtain a decorative layer pre-formed material; when the mixer is stirring at a low speed, its operating frequency is 10-20 Hz.

C. Spreading the decorative layer pre-formed material in a mold frame, pre-pressing with a pressure of 0.1 MPa to 0.3 MPa to obtain the decorative layer;

D. Transferring the calcium carbonate stone and the dispersion of pigment and resin into the trough, stirring at a low speed for 4-6 minutes to obtain a bottom layer pre-formed material; when the mixer is stirring at a low speed, its operating frequency is 10-20 Hz.

E. Spreading the bottom layer pre-formed material on the upper surface of the decorative layer in the mold frame; pressing with a pressure of 1-2 MPa to form the bottom layer which binds to the decorative layer to form a primary preliminary stone surface.

When the multilayer artificial stone contains a bottom decorative layer, a step E1 is included: spreading the decorative layer pre-formed material on the upper surface of the bottom layer in the mold frame; pressing with a pressure of 1-2 MPa to obtain a preliminary stone surface.

F. Curing the preliminary stone surface in a curing oven; polishing the surface of the decorative layer to obtain the multilayer artificial stone.

Particularly, the decorative stone is glass sand and/or a quartz stone, the particle size of the glass sand is 80 mesh, the particle size of the quartz stone is 325 mesh. The pre-pressing step is carried out via a pre-pressing roller. In step F, the curing temperature of the curing oven is 70-110° C.

Following the components and preparation method stated above, the amount of each component is adjusted in other embodiments to obtain different multilayer artificial stones with decorative layers, bottom layers, and bottom decorative layers. The qualities of the products obtained are compared; see Table 4-6 below.

TABLE 4
Components of the Decorative Layer

| | Components of the decorative layer and the bottom | | | | | |
|---|---|---|---|---|---|---|
| | decorative layer (in percentage by weight) | | | | | Type of |
| | Decorative | Unsaturated | Coupling | Curing | Filler | decorative |
| Embodiment | stone | polyester resin | agent | agent | pigment | stone |
| 17 | 80 | 17.3 | 0.6 | 0.7 | 1.4 | Glass sand |
| 18 | 85 | 12.3 | 0.6 | 0.7 | 1.4 | |
| 19 | 90 | 7.3 | 0.6 | 0.7 | 1.4 | |
| 20 | 80 | 17.3 | 0.6 | 0.7 | 1.4 | Quartz sand |
| 21 | 85 | 12.3 | 0.6 | 0.7 | 1.4 | |
| 22 | 90 | 7.3 | 0.6 | 0.7 | 1.4 | |
| 23 | 80 | 17.3 | 0.6 | 0.7 | 1.4 | Glass sand |
| 24 | 85 | 8 | 1.0 | 1.0 | 5 | |
| 25 | 90 | 5 | 0.6 | 0.7 | 3.7 | |
| 26 | 80 | 15 | 2 | 1.2 | 1.8 | Quartz sand |
| 27 | 85 | 8.5 | 1.5 | 1.0 | 4 | |
| 28 | 90 | 7 | 1.0 | 1.0 | 1.0 | |
| 29 | 60 | 25 | 12 | 1.2 | 1.8 | |
| 30 | 91 | 3.5 | 0.5 | 1.0 | 4 | |
| 31 | 90 | 7 | 1.0 | 1.0 | 1.0 | |
| 32 | 85 | 8.5 | 1.5 | 1.0 | 4 | |

TABLE 5
Components of the Bottom Layer

| | Components of the bottom layer | | | | | |
|---|---|---|---|---|---|---|
| | (in percentage by weight) | | | | | Type of |
| | Calcium | | | | | calcium |
| | carbonate | Unsaturated | Coupling | Curing | Filler | carbonate |
| Embodiment | stone | polyester resin | agent | agent | pigment | stone |
| 17 | 65 | 18 | 0.8 | 1.2 | 15 | Calcium |
| 18 | 70 | 15 | 0.6 | 1.0 | 13.4 | carbonate |
| 19 | 78 | 10 | 2 | 1.2 | 8.8 | |
| 20 | 65 | 18 | 2 | 1.2 | 13.8 | |
| 21 | 70 | 13 | 2 | 1.2 | 13.8 | |
| 22 | 78 | 16 | 1.3 | 0.7 | 4 | |
| 23 | 65 | 18 | 2 | 1.2 | 13.8 | |
| 24 | 70 | 13 | 2 | 1.2 | 13.8 | |
| 25 | 78 | 10 | 2 | 1.2 | 8.8 | |
| 26 | 65 | 18 | 2 | 1.2 | 13.8 | |
| 27 | 70 | 13 | 2 | 1.2 | 13.8 | |
| 28 | 78 | 18 | 2 | 1.0 | 1.0 | |
| 29 | 65 | 18 | 2 | 1.2 | 13.8 | |
| 30 | 70 | 13 | 2 | 1.2 | 13.8 | |
| 31 | 48 | 28 | 13 | 10 | 1.0 | |

TABLE 6
Properties of Multilayer Artificial Stone

| | Thickness of | | | |
|---|---|---|---|---|
| | the decora- | | Heating | |
| | tive layer | Thickness | temper- | |
| | or the bottom | of the | ature in | |
| Embodi- | decorative | bottom | step A | Product quality |
| ment | layer (cm) | layer (cm) | (° C.) | testing results |
| 17 | 0.5 | 0.5 | 30 | Good |
| 18 | 1.0 | 1.5 | 40 | Good |
| 19 | 1.5 | 2.5 | 50 | Good |
| 20 | 0.5 | 1.0 | 30 | Good |
| 21 | 1.0 | 2.0 | 40 | Good |
| 22 | 1.5 | 2.0 | 50 | Good |
| 23 | 0.5 | 0.5 | 30 | Good |
| 24 | 1.0 | 1.5 | 40 | Good |
| 25 | 1.5 | 2.5 | 50 | Good |
| 26 | 0.5 | 1.0 | 30 | Good |
| 27 | 1.0 | 2.0 | 40 | Good |
| 28 | 1.5 | 2.0 | 50 | Good |
| 29 | 0.5 | 1.0 | 30 | Poor decorative |
| | | | | effect |
| 30 | 1.0 | 2.0 | 40 | Serious cracking |
| 31 | 1.5 | 2.0 | 50 | Cracking |
| 32 | 3.0 | 1.0 | 40 | Deformation |

It can be concluded from embodiments 1 to 32 in Tables 1 to 6 that when the percentages of the components of each layer of the multilayer artificial stone are not within the specified range, the surface of the product either has a poor decorative effect or the stone surface deforms. In some scenario, even cracking occurs.

It should be noted that for the decorative layer, the bottom layer, and the bottom decorative layer, the unsaturated polyester resin is 721-9 resin from Nantong Tianhe Resin Co., Ltd.; the coupling agent is a silane coupling agent purchased from GBXF Silicones Co., Ltd, product number GX570. The curing agent is purchased from Lianyungang Sino More New Material Co., Ltd., product number V8. The filler pigment includes Ti-Pure® R-706 from DuPont, yellow and black filler pigment from Bayferrox. These materials are not limited to the aforementioned products.

The present invention provides a multilayer artificial stone and its preparation method. In the preparation method, a decorative layer, a bottom layer, and a bottom decorative layer are prepared separately and then bound together by pressing to form an integral body. The bottom layer is mainly made from calcium carbonate, which is low in cost. The more expensive decorative stone is used to make the decorative layer, which is exposed to the outside. In this way, desirable decorative effect and product quality can be obtained. In addition, each layer contains only one kind of stone; therefore, the production process can be more easily and accurately controlled, lowering production cost.

The technical principles of the present invention have been described above in combination with the specific embodiments. The descriptions are merely illustrative of the principles of the invention and are not considered to limit the scope of the invention. Based on the description herein, those skilled in the art can propose other embodiments of the present invention without any creative effort; all of these embodiments shall fall within the protection scope of the present invention.

What is claimed is:

1. A multilayer artificial stone, wherein it comprises a decorative layer and a bottom layer which are arranged from top to bottom, the decorative layer and the bottom layer bind together to form an integral body;
the decorative layer comprises the following components in percentage by weight:
80%-90% of a decorative stone, 5%-15% of an unsaturated polyester resin, 0.6%-2% of a coupling agent, 0.7%-1.2% of a curing agent, and 1%-5% of a pigment filler;
the bottom layer comprises the following components in percentage by weight: 65%-78% of a calcium carbonate stone, 10%-18% of an unsaturated polyester resin, 0.6%-2% of a coupling agent, 0.7%-1.2% of a curing agent, and 1-15% of a pigment filler.

2. The multilayer artificial stone according to claim 1, wherein a bottom decorative layer is provided underneath the bottom layer; the bottom decorative layer and the bottom layer bind together to form an integral body; the bottom decorative layer comprises the following components in percentage by weight: 80%-90% of a decorative stone, 5%-15% of an unsaturated polyester resin, 0.6%-2% of a coupling agent, 0.7%-1.2% of a curing agent, and 1%-5% of a pigment filler.

3. The multilayer artificial stone according to claim 2, wherein the decorative stone is glass sand and/or a quartz stone.

4. The multilayer artificial stone according to claim 2, wherein a thickness of the decorative layer or the bottom decorative layer is 0.5 cm to 1.5 cm; a thickness of the bottom layer is 0.5 cm to 2.5 cm.

5. The multilayer artificial stone according to claim 3, wherein the glass sand has a particle size of 26-150 mesh, the quartz stone is quartz powder, the quartz powder has a particle size of 200-450 mesh.

6. A method to prepare the multilayer artificial stone according to claim 1, wherein it comprises the following steps:
A: heating the unsaturated polyester resin to 20-30° C.; adding the coupling agent, the curing agent, and the pigment filler; stirring thoroughly to obtain a dispersion of pigment and resin;
B. adding the decorative stone and the dispersion of pigment and resin into a trough, stirring thoroughly to obtain a decorative layer pre-formed material;
C. spreading the decorative layer pre-formed material in a mold frame, pre-pressing to obtain the decorative layer;
D. transferring the calcium carbonate stone and the dispersion of pigment and resin into the trough, stirring thoroughly to obtain a bottom layer pre-formed material;
E. spreading the bottom layer pre-formed material on an upper surface of the decorative layer in the mold frame; pressing to form the bottom layer which binds to the decorative layer to form a primary preliminary stone surface;
F. curing the primary preliminary stone surface in a curing oven; polishing a surface of the decorative layer to obtain the multilayer artificial stone.

7. The method according to claim 6, wherein a step E1 is provided between step E and step F:
E1. spreading the decorative layer pre-formed material on an upper surface of the bottom layer in the mold frame; pressing to obtain a preliminary stone surface;
Wherein in step F, the preliminary stone surface is cured in the curing oven stead of the primary preliminary stone surface.

8. The method according to claim 6, wherein the stirring in step A involves stirring at a high speed for 1-2 minutes; when a mixer is stirring at the high speed, its operating frequency is 40-60 Hz; the stirring in step B and step D involves stirring at a low speed for 4-6 minutes; when the mixer is stirring at the low speed, its operating frequency is 10-20 Hz.

9. The method according to claim 6, wherein the pre-pressing is performed under a pressure of 0.1 MPa to 0.3 MPa; the pressing is performed under a pressure of 1 MPa to 2 MPa.

10. The method according to claim 6, wherein in step F, the curing of the primary preliminary stone surface is carried out at a temperature of 70-110° C.
